(19) United States
(12) Patent Application Publication
(10) Pub. No.: US 2020/0232635 A1
(43) Pub. Date: Jul. 23, 2020

(54) Heated Light Apparatus

(71) Applicant: James Carl Parson, Calgary (CA)

(72) Inventor: James Carl Parson, Calgary (CA)

(21) Appl. No.: 16/250,803

(22) Filed: Jan. 17, 2019

(51) Int. Cl. F21V 29/90; F21V 23/02; H05B 3/86

(52) U.S. Cl. CPC F21V 29/90; F21Y 2115/10; H05B 3/86; F21V 23/02

(57) ABSTRACT

A heated light apparatus has a light source that includes at least one illumination element arranged to produce a light beam. The illumination element may be a light emitting diode. A lens assembly is positioned in front of the at least one illumination element in order to focus the light beam therefrom. The lens assembly has a defroster grid circuit that generates heat as electrical current passes therethrough. A power source provides electrical current to the light source and the lens assembly, such that the defroster grid circuit produces heat sufficient to melt ice and snow buildup on the lens assembly.

### REFERENCE TO PENDING APPLICATIONS

This application does not claim the benefit of any issued U.S. Patent or pending application.

### TECHNICAL FIELD

The present invention relates generally toward vehicle safety in inclement weather, and more specifically a heated light capable of reducing ice and snow buildup thereon.

### BACKGROUND

One of the most important aspects of vehicle safety is visibility. Drivers want to ensure that other drivers can see their vehicle. This is especially true during inclement weather, such as snow and/or ice storms. If a vehicle's lights, e.g. brake lights, side marker lights, etc., cannot be seen by other drivers, the risk of an accident increase.

Further, if a driver of a tractor trailer vehicle cannot see the trailer portion of the vehicle due to the side marker lights not be visible, the driver will have difficulty observing how well the trailer is following the truck, or where the trailer is relative to corners and obstructions.

In order to enhance visibility, vehicles often have side mounted lights. These lights provide additional safety for the vehicle and for other drivers on the roadway.

However, in inclement winter weather conditions, snow and ice may accumulate on the vehicle and cover the side lights, as well as the rear lights including the brake lights. This prevents the illumination of those lights to be seen by by other drivers on the roadway. This can create unsafe driving conditions which can lead to vehicular accidents causing damage and possibly death.

Accordingly, there is a need for a device to address the challenges set out above.

### SUMMARY

The present invention relates generally toward vehicle safety in inclement weather, and more specifically a heated light capable of reducing ice and snow buildup thereon.

In one aspect, a heated light apparatus for use with a vehicle is disclosed. The heated light apparatus includes a light source having at least one illumination element arranged to produce a light beam. The illumination element may be one or more light emitting diodes.

A lens assembly is positioned in front of the at least one illumination element in order to focus the light beam. The lens assembly has a defroster grid circuit that generates heat as electrical current passes therethrough. The amount of heat is sufficient to melt ice and snow buildup on the lens assembly. A power source provides electrical current to the light source and the lens assembly.

In some aspects, the defroster grid circuit may be affixed to the interior surface of the lens assembly. In other aspects, the defroster grid circuit may be embedded within the lens assembly.

In some aspects, the defroster grid circuit include conductive wire having a resistance sufficient to generate heat as electrical current passes therethrough, electrically conductive tape having a resistance, electrically conductive paint applied directly to the lens assembly, or a combination thereof.

In some aspects, the heated light apparatus may also include an electronic circuit having a thermistor resistor. The electronic circuit is connected to the defroster grid circuit and can intermittently turning the defroster grid circuit on and off based off the temperature of the thermistor resistor.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a cross-sectional side block view of an embodiment of the present invention.

FIG. 2 is a top block view of an embodiment of the present invention.

FIG. 3 is a block diagram of an embodiment of the present invention.

FIG. 4 is a block diagram of an additional embodiment of the present invention.

### DETAILED DESCRIPTION OF THE INVENTION

The present invention is directed toward a heated light apparatus. This apparatus is designed to produce heat through a defrost grid circuit having conductive material having resistance. The amount of heat produced is sufficient to melt accumulations of ice and snow upon the apparatus.

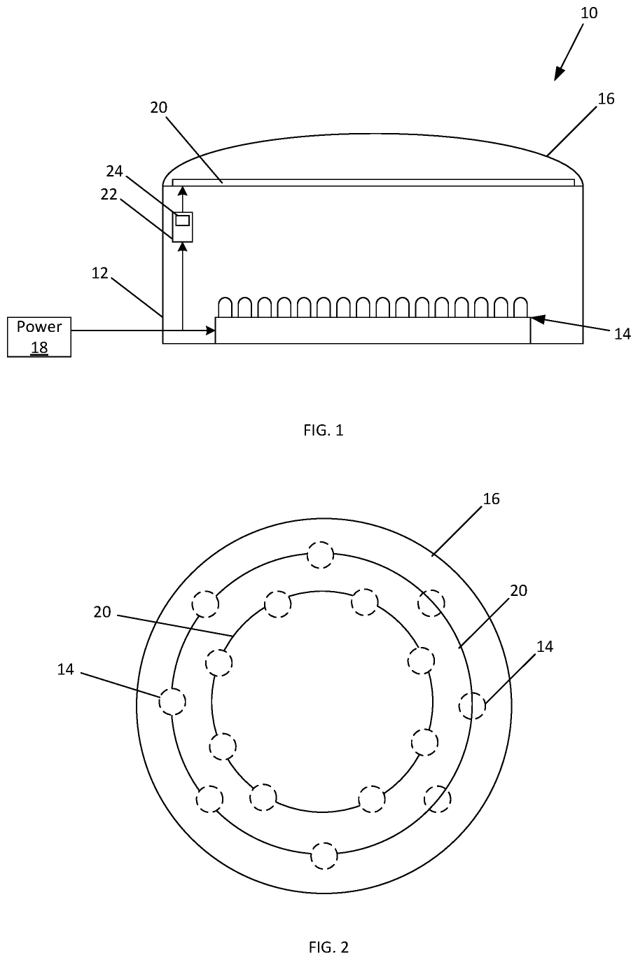

As illustrated in FIGS. 1 and 2, an embodiment of a heated light apparatus 10 is disclosed. Heated light apparatus 10 is may be utilized as an external light for a vehicle. For example, the external light may be a side marker light, a rear brake light or other external lights. As heated light assembly may be configured to replace existing vehicle lights, heating light apparatus 10 may be to be installed without the need for any specific retrofitting of the vehicle.

Heated light apparatus 10 includes a light source assembly 12. The light source assembly 12 has at least one illumination element 14 arranged to produce a light beam. Illumination element 14 may be any light producing element such as a light emitting diode.

A lens assembly 16 is positioned in front of illumination element 14 and focuses the produced light beam. Lens assembly 16 has a defroster grid circuit 20 that generates heat as electrical current passes therethrough. Power to lens assembly 16 is provided with power is provided to heated light apparatus 10. Defroster grid circuit 20 is a heat producing circuit when activated, with the amount of heat produced being sufficient to evaporate fog and melt ice and snow buildup on the lens assembly 16. In some embodiments, defroster grid circuit 20 may be affixed to the interior surface of lens assembly 16 or may be embedded within lens assembly 16.

Defroster grid circuit 20 may be any circuit that produces heat. In some embodiments, defroster grid circuit 20 may include any type of conductive material that has a resistance that produces heat when an electrical current passes therethrough. This conductive material may be conductive wire, electrically conductive tape, electrically conductive paint that may be applied directly to the lens assembly, or any other suitable conductive material.

A power source 18 provides the electrical current to illumination element 14 and defroster grid circuit 20. Power source 18 is typically the vehicle's battery but may be another power source located within the vehicle. Further, power source 18 is typically turned on and off by the operator of the vehicle. In operation, when electrical current from power source 18 is provided to illumination element 14, electrical current is also provided to defroster grid circuit 20.

In some embodiments, heated light apparatus 10 may also include an electronic circuit 22 having a thermistor resistor 24. The electronic circuit is connected to the defroster grid circuit 20 and intermittently turns the defroster grid circuit 20 on and off based on the temperature of thermistor resistor 24.

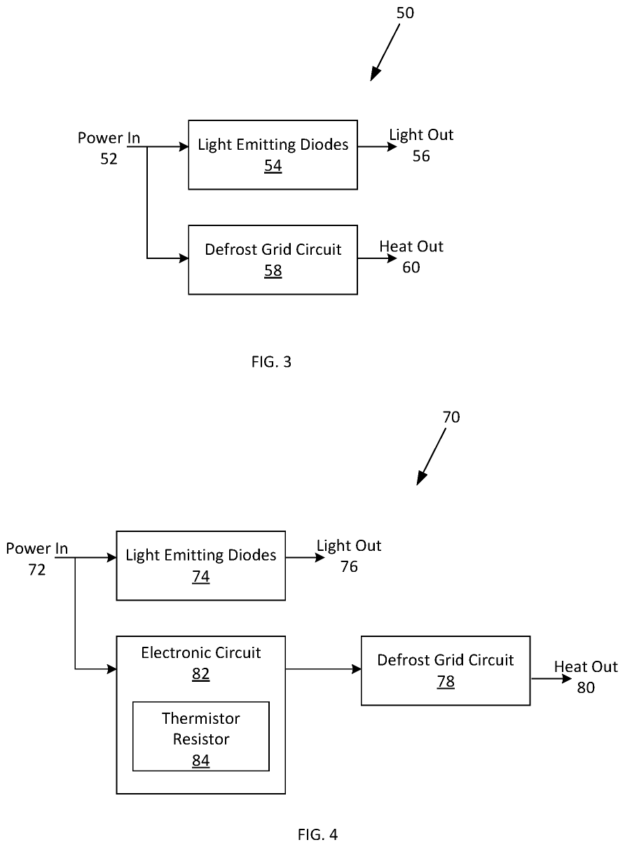

As illustrated in FIG. 3, a block diagram of an embodiment of the heated light apparatus 50 of the present invention is disclosed. Power 52 is supplied to one or more light emitting diodes 54 which in turn provides light 56. Further, power 52 is supplied to defrost grid circuit 58 which in turn provides heat 60.

As illustrated in FIG. 4, a block diagram of an additional embodiment of the heated light apparatus 70 of the present invention is disclosed. Power 72 is supplied to one or more light emitting diodes 74 which in turn provides light 76. Further, power 72 is also supplied to defrost grid circuit 78 which in turn provides heat out 80. Defrost grid circuit 78 is operated by electronic circuit 82 having a thermistor resistor 84. Thermistor resistor 84 is dependent on temperature. As electrical current from power 72 flows through thermistor resistor 84, heat is generated which in turn increases thermistor resistor's 84 temperature. Once the temperature of thermistor reaches 84 an upper temperature value, which may be a temperature sufficient to cause damage to electronic circuit 82 and/or defrost grid circuit 78 power is turned off to defrost grid circuit 82 which in turn allows for the temperature of defrost grid circuit 82 and thermistor resistor 84 to cool.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

1. A heated light apparatus comprising:
a light source assembly, the light source assembly including at least one illumination element arranged to produce a light beam;
a lens assembly positioned in front of the at least one illumination element for focusing the light beam therefrom, the lens assembly having a defroster grid circuit that generates heat as electrical current passes therethrough; and
a power source for providing electrical current to the at least one illumination element and the lens assembly,
wherein the defroster grid circuit includes electrically conductive tape having a resistance sufficient to generate heat as electrical current passes therethrough.

2. The heated light apparatus of claim 1, wherein the at least one illumination element is at least one light emitting diode.

3. The heated light apparatus of claim 1, further comprising:
an electronic circuit having a thermistor resistor, the electronic circuit connected to the defroster grid circuit intermittently turning the defroster grid circuit on and off, wherein the power source provides electrical current to the electronic circuit.

4. The heated light apparatus of claim 1, wherein the defroster grid circuit is affixed to the interior surface of the lens assembly.

5. The heated light apparatus of claim 1, wherein the defroster grid circuit is embedded within the lens assembly.

6. The heated light apparatus of claim 1, wherein the defroster grid circuit comprises: conductive wire having a resistance sufficient to generate heat as electrical current passes therethrough.

7. (canceled)

8. The heated light apparatus of claim 1, wherein the defroster grid circuit comprises:
either one or both of an electrically conductive paint applied directly to the lens assembly and an electrically conductive tape, the electrically conductive paint and the electrically conductive tape having a resistance sufficient to generate heat as electrical current passes therethrough.
